(19) United States
(12) Patent Application Publication
(10) Pub. No.: US 2013/0054812 A1
(43) Pub. Date: Feb. 28, 2013

(54) SYSTEM AND METHOD FOR DYNAMICALLY ASSEMBLING AN APPLICATION ON A CLIENT DEVICE

(71) Applicant: Don DeCoteau, San Diego, CA (US)

(72) Inventor: Don DeCoteau, San Diego, CA (US)

(21) Appl. No.: 13/586,406

(22) Filed: Aug. 15, 2012

Related U.S. Application Data
(60) Provisional application No. 61/526,255, filed on Aug. 22, 2011.

(51) Int. Cl. G06F 15/173

(52) U.S. Cl. 709/226

(57) ABSTRACT

A system and method for dynamically assembling an application for execution on a first device from a platform-independent application configuration and executing the application on the first device all in near real-time. A Real-time Application Rendering Engine (RARE) may be capable of building, in near real-time, native applications. The native applications may be built in near real-time from a set of one or more of library(ies), script(s), configuration(s), UI markup file(s), and/or other elements. These elements may exist on the local device, they may be retrieved via a browser, or the RTE, accessing content at a public or private network, using any available network protocol, or they may be obtained in other ways.

### CROSS REFERENCE TO RELATED APPLICATION

This application claims priority under 35 U.S.C. §119(e) from provisional U.S. Ser. No. 61/526,255, filed Aug. 22, 2011, the contents of which are incorporated herein by reference in its entirety.

### FIELD OF THE INVENTION

The invention relates to a system and method for dynamically assembling an application for execution on a first device from a platform-independent application configuration received from a second device.

### BACKGROUND OF THE INVENTION

Traditionally, applications are either delivered as browser-based applications, running within the context of a web browser, or as native applications, running on the operating system of the target device.

With browser-based applications, the ability to distribute applications as a set of web pages and scripts may provide flexibility at the point of execution, as the application may be customized on a per-invocation basis. The browser, however, is “the application” and the hosted code of the application is limited by the constraints of the browser, the browser's standards support, and the browser vendor's bug fixing and upgrade cycle. While this approach may provide a cost effective way of covering the most platforms and devices, it is also the weakest in terms of user experience and functionality.

The emergence of cloud-based services which deliver applications to enterprise customers may also encounter similar issues. Conventionally, these cloud-based applications are also delivered via web browser. Thus, cloud-based applications may pose a significant software management and maintenance challenge for application developers as well.

With native applications, the ability to distribute native applications may offer power and flexibility in terms of building applications that can take full advantage of the capabilities of the target device. A native application may be richer and more functional than anything that can be achieved in a browser-based application. Once deployed, however, these applications offer limited or no flexibility or customizability. For example, in order to update or fix the application, every device which has the application needs to be touched to upgrade/fix the application. Native applications may also be more costly to maintain when targeting multiple platforms.

Conventional systems and methods for providing applications suffer from these and other problems.

### SUMMARY OF THE INVENTION

One aspect of this disclosure relates to a system and method for dynamically assembling an application for execution on a first device from a platform-independent application configuration received from a second device. A Real-time Application Rendering Engine (RARE) may be capable of building, at near real-time, native applications. The native applications may be built at near real-time from a set of one or more of library(ies), script(s), configuration(s), UI markup file(s), and/or other elements. These elements may exist on the user's local device, they may be retrieved via a browser accessing content at a public or private network, using any available network protocol, or they may be obtained in other ways.

In some implementations, the RARE engine may be a browser or comprise browser functionality. In some examples, the RARE engine may also rely on an external browser. For example, the RARE engine may rely on an external browser to handle content that it may not know how to handle. In another example, the RARE engine may rely on an external browser to access and/or receive application configuration information. In some implementations, a first computing device including the RARE engine may be configured to execute one or more computer modules. The computer modules may include one or more of a network module, a run-time environment (RTE) module, and/or other modules.

The network module may be configured to receive application assembly instructions from a server and/or from other sources. In some implementations, the network module may facilitate communication with other computing devices via a network. In some examples, the network module of the computing device may be separate from the RARE engine.

The RTE module may be configured to retrieve application resources, assemble an application based on the retrieved application resources, and/or perform other functions. In some implementations, the RTE module may assemble and/or render an application for interaction and display via the browser functionality of the device's native platform. The RTE module may include a plurality of computing modules. For example, RTE module may include one or more of a resource retrieval module, a storage module, an assembling module, a scripting module, an execution module, a web proxy and/or URL rewriting module, and/or other modules. The RTE module may also include platform-specific and/or application-specific modules, including, for example, encryption modules, customized display modules, and/or other platform-specific or application-specific modules.

The resource retrieval module may be configured to retrieve one or more application resources based on one or more respective URLs identified in the application configuration. In some implementations, the resource retrieval module may analyze the application configuration and adapt the generated application based on said analysis. The application configuration may include information for assembling an application. For example, the information for assembling the application may include one or more of metadata identifying the application and conditions for application generation on specific device types and platforms, one or more URLs pointing to one or more respective locations at which one or more respective application resources exist, and/or other information. In some implementations, the resource retrieval module may retrieve one or more application resources based on the one or more URLs in the application configuration. The resources may include, for example, one or more sets of libraries, scripts, configurations and UI markup files, formatting information, data for the application, and/or other resources. In some implementations, the resource retrieval module may also determine a type of the application resource that is retrieved. For example, the resource retrieval module may determine, by context and/or a MIME type of the data at the resource location, a type of the application resource that is retrieved. The types of resources retrieved may include one or more of native code (e.g. DLLs, or Shared Libraries), Virtual Machine byte code, scripts (e.g. JavaScript, Ruby, Python), configuration and UI markup files, and/or other types of resources. In some examples, the resource retrieval module may determine how to handle the resource based on the resource type. If no context data exists, the resource retrieval module may rely on the MIME type of the data to determine the type of the resource. If context data does exist, the resource retrieval module may determine a type of the data within the specified context. For example, the resource retrieval module may use context to determine that an application resource includes a list-type component based on data available at a resource. In some implementations, the MIME type of the data may be imposed by the resource retrieval module (e.g., the resource retrieval module may impose a type of resource based on a specific MIME type regardless of a MIME type conventionally associated with the data at the resource).

The storage module may be configured to store the one or more application resources. For example, the storage module may include one or more storages that store the various resources retrieved by the resource retrieval module.

The assembling module may be configured to assemble the application based on one or more application resources. For example, the assembling module may assemble the application based on the resources retrieved and stored in the storage. In some examples, the assembling module may determine how to handle a resource based on the resource type. If no context data exists, the assembling module may rely on the MIME type of the data to determine how to handle the resource. If context data does exist, the assembling module may interpret the data within the specified context (e.g., how to present data to a user, whether to use data at the resource to populate a table for presentation to the user). For example, the assembling module may use context to determine that list-type components (e.g., tables, lists, trees, etc.) are to be configured, populated, filtered, and/or searched using or based on data available at a resource. In some implementations, the MIME type of the data can be imposed by the assembling module. In some implementations, the assembling module of the RTE module may include one or more computer modules. For example, the assembling module may include one or more of a layout module, a widget module, and/or other modules.

The layout module may format data of a retrieved resource for display via the application. For example, the layout module may use a RenderableDataItem entity or data object to display or format data. The RenderableDataItem object may represent data to be displayed or handled by the application. The RenderableDataItem object may include one or more attributes which specify that data represented by the object be displayed with one or more features of one or more respective attributes. For example, the RenderableDataItem object may include one or more attributes able to specify one or more features. The one or more features may include one or more of font, color, drag and drop support, column/row spanning, nesting, or the use of custom data renderers, and/or other features.

The widget module may format and/or render data for display in a widget. A widget may be an element of a graphical user interface (i.e. an element via which the application is displayed) that displays data in an arrangement that is able to be manipulated by a user. For example, the widget module may be able to render an element for display in an application window. The widget module may be configured to render both generic elements (e.g., a text box, a button, a drop-down list, a menu, a toolbar, a link, a window, etc.) as well as application-specific or platform-specific elements (e.g., a biometric input, feature recognition input, etc.).

The scripting module may provide a scripting environment for use in the application. The scripting module may also execute event handlers and other script code. In some examples, the application configuration may include a URL that identifies a location at which a script may be stored and/or accessed. The resource retrieval module may retrieve the script from the location represented by the URL. The storage module may store the script. The assembling module may determine that the application resource is a script. The scripting module may be used to load the script after it has been retrieved and stored. In some examples, the scripting module may allow scripts written in different languages to execute and operate as part of a single application. In some implementations, once the script has been stored, the script may be globally accessible at the device and/or for the application. In some implementations, the scripting module may also have access to native libraries and other resources available on the device.

The execution module may be configured to run and/or execute the assembled application.

The web proxy and/or URL rewriting module may manage web services for the application. In some examples, the web proxy may be a web server included in the RTE module. In some examples, the web proxy and/or URL rewriting module may manage session cookies and other HTTP state/security information. These modules may also make the session cookies and other state information available to native components. For example, the web proxy module and URL rewriting module may make session cookies and HTTP state information available to components that may want web access to secured application resources. In some implementations, the web proxy and/or URL rewriting modules may facilitate communication of session information and/or other HTTP state/security information to one or more external components. For example, when an application displays information via an external component, the RTE module may use the URL rewriting module to create a special URL that points to the web proxy module. The RTE module may launch the external application with the special URL created by the URL rewriting module. The web proxy module may then use the resource retrieval module to retrieve a resource at the original URL. The web proxy module and/or the resource retrieval module may send the retrieved resource to the external application. In some examples, an external component may include one or more an external browser, a PDF viewer, a movie player, and/or other external components.

In some implementations, the RTE module may augment or replace prebuilt components, interactions, and resources of the application at or near runtime. In some implementations, the RTE module has certain built-in features. For example, the RTE module may include one or more built-in components, interactions, resources, and/or other built-in features that it may use when assembling an application based on an application configuration. In some examples, the application configuration may specify replacements for one or more of the built-in features. In some examples, an application configuration may specify an alternate feature to be used instead of the default feature for the application. For example, the application configuration may include a URL identifying a location at which a resource including the alternative feature may be available. The data at the URL may be retrieved and assembled as part of the application at or near run-time.

In some implementations, one or more of the resources retrieved may include code that accesses the native resources of the device to obtain information relating to the device or the user of the device. In another example, one of the retrieved resources may be a script that accesses native resources and/or native libraries of the device to obtain information relating to the device or the user of the device. The assembling module may execute the code (or script) during or near a runtime of the assembled application. The assembling module may include information native to the device in assembling the application. For example, the assembling module may assemble the application based on any criteria that the application provider chooses, including, for example, user preferences, device characteristics, security constraints, user's physical location, user's language, and other criteria.

In some implementations, the application configuration and resources (and assembled application) may exist entirely on the device's file system and run like any other native application. In some implementations, the application configuration and resources may exist entirely in the cloud. In some of the cloud-based implementations, a computing device with the RARE engine will download resources for assembling the application (e.g., the markup, images, script code, any supplemental libraries, etc.). In some implementations, the computing device may assemble the application in near real-time. In some implementations, network latency may be the only difference in startup time between local and cloud hosted applications. In some implementations, the assembled application may be run from a local copy on the computing device and may transition to a cloud-based version of the application.

In some implementations, a second computing device may include a RARE engine similar to the RARE engine discussed with respect to the first computing device. The RARE engine of the second computing device may be configured to execute one or more computer modules in addition to those discussed above. The computer modules may include one or more of an application configuration generation module and/or other modules.

The application configuration generation module may be configured to prepare an application configuration associated with the application to be launched. The application configuration generation module may include one or more computing modules. For example, the application configuration generation module may include one or more of an application storage module, a profile storage module, a configuration request and delivery module, a configuration generation module, and/or other modules.

In some implementations, the application storage module may comprise a plurality of applications available at the second computing device. The application storage module may also comprise a plurality of resources associated with a stored application. For example, for a stored application, the application storage module may store one or more resources necessary for the application to be executed and one or more resources that are optional to the application. These optional resources may provide features including, for example, additional functionality, more versatile display, increased user interactivity, and/or other features. In some implementations, the application storage module may store a list of resources available for an application. In some implementations, the application storage module may store identifiers for the necessary and optional resources associated with the application. For example, the application storage module may store a URL identifying a location of the resource. In another example, the application storage module may store an address corresponding to a location in a memory of the second computing device at which the resource may be stored. The memory may be, for example, part of or separate from the application storage module. In some examples, the memory may reside on one or more separate devices.

In some examples, for a resource associated with the application, a set of one or more resources may be stored. The set of resources may comprise one or more resources providing one or more respective ways of providing same or similar functionality. For example, a resource may be program code to provide a function to be included in the application. One way of providing the program code would be to provide program code in a first language. Another way of providing program code would be to provide the program code in a second language different from the first language. Another way of providing program code would be to provide a script in a first language that provides the functionality of the program code. One or more ways of providing the functionality of the resource may be associated with a resource in the application storage module. In some implementations, the application storage module may store a default resource that provides a specific functionality. The application storage module may also store one or more associated resources that provide the same or similar functionality. The application storage module may also store the features or differences between the associated along with the association to the resource.

In some implementations, the profile storage may store profile information for a user and/or profile information for a device. In some implementations, a user may be associated with a device. The user profile information may include user information and user preferences associated with the user. The user information may include one or more of user name, user email address, user devices, IP addresses associated with the user, a user identifier (e.g., a name, number, or other type of identifier), and/or other user information. The user preferences may include one or more of display preferences, interactivity preferences, security preferences, physical location, language preferences, and/or other preferences. The device profile information may include device information and/or device constraints. The device information may include one or more of a type of the device, a user associated with the device, an IP address associated with the device, device capabilities, and/or other device information. The device constraints may include one or more of accepted coding languages, accepted script types and/or languages, display and/or format constraints, libraries or resources native to the device, and/or other constraints.

In some implementations, the configuration request and delivery module may be configured to receive one or more requests for one or more respective applications from one or more computing devices. The configuration request and delivery module may also be configured to facilitate the delivery of an application configuration based on a request received from a computing device. In some implementations, the request comprises at least an application identifier and an IP address to which the application should be delivered. The request may also comprise one or more of user information, device information, application constraints, application preferences, and/or other request data.

The configuration request and delivery module may store the request at the second computing device. For example, the configuration request and delivery module may store the request in the application storage module and/or the profile storage module. The configuration request and delivery module may also facilitate access of the request to the configuration generation module. When the configuration generation module has prepared an application configuration, the configuration request and delivery module may facilitate delivery of that application configuration to the requesting computing device and/or the IP address specified in the request.

In some implementations, the configuration generation module may prepare an application configuration. For example, the application configuration generation module may prepare an application based on a request received via the configuration request and delivery module. The configuration generation module may prepare the application configuration based on information included in the request. For example, the application configuration generation module may prepare the application configuration based on one or more of the application requested, user information, profile information, constraints, preferences, and/or other information included in the request. In some examples, the configuration generation module may select resources for use in assembling the application. For example, the configuration generation module may select resources for the application based on the necessary resources for that module and based on available optional resources that coincide with information in the request. As discussed above, the configuration generation module may include location identifiers to the selected resources in the application configuration.

Other objects and advantages of the invention will be apparent to those skilled in the art based on the following drawings and detailed description.

### BRIEF DESCRIPTION OF THE DRAWINGS

FIG. 1 illustrates an exemplary diagram of a system for dynamically assembling an application on a receiving device, according to an implementation of the invention.

FIG. 2 illustrates an exemplary diagram of a system for dynamically assembling an application on a receiving device, according to an implementation of the invention.

FIG. 3 illustrates an exemplary diagram of a system for dynamically assembling an application on a receiving device, according to an implementation of the invention.

FIG. 4 illustrates an exemplary flowchart for dynamically assembling an application on a receiving device, according to an implementation of the invention.

FIGS. 5A and 5B illustrate exemplary flowcharts for dynamically assembling an application on a receiving device, according to an implementation of the invention.

FIG. 6 illustrates an exemplary device including a RARE engine, according to an implementation of the invention.

FIGS. 7A and 7B illustrate a flow chart for launching an application using an application configuration, according to an implementation of the invention.

FIG. 8 illustrates an exemplary diagram of a computing device for dynamically assembling an application on a receiving device, according to an implementation of the invention.

### DETAILED DESCRIPTION

A system and method for dynamically assembling an application on a client device from a platform-independent application configuration delivered via a browser may be provided.

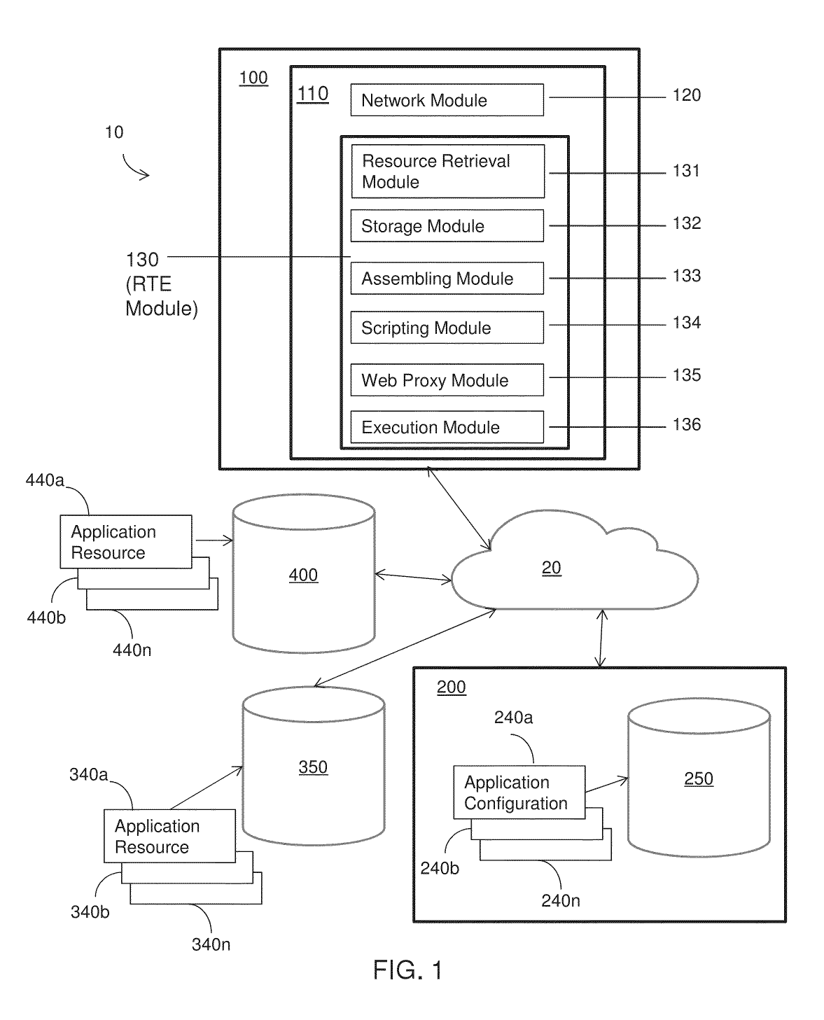

FIG. 1 illustrates an exemplary diagram of a system 10 for dynamically assembling an application (not shown) on a receiving device 100, according to an implementation of the invention. The system 10 may include a network 20, a receiving device 100, a sending device 200, and one or more repositories 250, 350, 450, that include application resources 240a-n, 340a-n, and 440a-n, respectively. The receiving device 100 may include a RARE engine 110 comprising a network module 120 and a RTE module 130. The receiving device 100 may receive an application configuration and may access, based on the application configuration, application resources from one or more of the repositories 250, 350, 450. The receiving device 100 may use the application resources to dynamically assemble an application relating to the application configuration.

An application may comprise computer software designed to execute on a computing device. For example, the software may facilitate, for a user of the computing device, access to and/or completion of one or more tasks on the computing device. The computing device 10 may assemble an application after receiving an application configuration (not shown). In some implementations, the application may be an application for use on a computing device 10. In some implementations, the application may be an application for use via a browser running on computing device 10. For example, the application may be a mobile application that may run via a browser on a mobile phone. In another example, the application configuration may be received via a browser on a mobile phone and may run via firmware and/or hardware on the mobile phone. In another example, the application configuration may be received directly by the RARE engine being invoked with the URL for the application configuration and may run via firmware and/or hardware on the mobile phone. The type of the application and method by which the application configuration is received are not limited to the examples described herein.

As shown in FIG. 1, the system 10 may include a receiving device 100 comprising a RARE engine 110. In some implementations, the RARE engine 110 may be a browser or comprise browser functionality. In some examples, the RARE engine 110 may also rely on an external browser. For example, the RARE engine 110 may rely on an external browser to handle content that it may not know how to handle. In another example, the RARE engine 110 may rely on an external browser to access and/or receive application configuration information. The RARE engine 110 may include one or more computing modules. For example, the RARE engine 110 may include one or more of a network module 120 and a RTE module 130. In some implementations, the network module 120 may facilitate communication with other computing devices via the network 20. The network module may also comprise browser functionality. For example, the network module may comprise browser functionality for one or more browsers. The RTE module 130 may include a plurality of modules including, for example, a resource retrieval module 131, a storage module 132, an assembling module 133, a scripting module 134, a web proxy module 135, an execution module 136, and/or other modules. In some implementations, the RTE module 130 may assemble an application for interaction and display via the browser functionality of the network module 120. In some implementations, the RTE module 130 may assemble an application for interaction and display via the browser functionality of the network module 120 for the RARE engine 110 and via browser functionality of the network module 120 for another browser. For example, the other browser may be a conventional browser.

In some implementations, the resource retrieval module 131 may receive an application configuration. For example, the resource retrieval module 131 may receive the application configuration from sending device 200. The resource retrieval module 131 may also receive the application configuration from another source via the network 20. For example, the sending device 200 may include an application repository (e.g., repository 250 or a portion thereof) at a cloud-based environment. In another example, the sending device 200 may comprise an application repository (e.g., repository 250 or a portion thereof) associated with a service provider of the receiving device 100. In another example, the resource retrieval module 131 may receive the application configuration from one or more of repositories 250, 350, 450. In another example, the resource retrieval module 131 may access the application configuration from hardware coupled to the receiving device 100, including, for example, from a local file system, SD card, flash memory drive, and/or other hardware.

In some examples, the resource retrieval module 131 may receive the application configuration based on a request for an application by the computing device 10. For example, the computing device 10 may send a request via network 20 and/or network module 120 for an application and may receive, via network 20 and/or network module 120, an application configuration corresponding to the requested application. The application configuration may be received by other methods as well.

An application configuration may be associated with one or more applications for use on a computing device. In some implementations, an application configuration may be associated with a single application. In some implementations, an application configuration may include at least metadata associating the configuration with the application and one or more URLs identifying locations at which one or more respective application resources may be located. In some implementations, the application resources may include, for example, one or more sets of libraries, scripts, configurations and UI markup files, formatting information, data for the application, and/or other resources.

In some implementations, the application configuration may be communicated using a browser at the receiving device 100. The browser may be a browser of the RARE engine 110. The browser may be any conventional browser. In some examples, the application configuration may also be communicated using any appropriate format such as a word processing document, one or more database entries, a plaintext document, an HTML/XML page, and/or other formats that can include at least the metadata and the one or more URLs included in the application configuration. In some implementations, the application configuration may be made publicly available for access and/or download via various communication channels such as, for example, via a webpage, a web portal, an agent (such as a software and/or hardware module) executing on a client device that communicates with the computing device, electronic mail and/or other communication channel that can be used to make the application configuration available to a user.

In some implementations, the receiving device 100 may include an agent (such as a software and/or hardware module) that facilitates the communication of an application configuration as described herein. For example, the agent may facilitate communication, via network 20 and network module 120, with, for example, sending device 200 and/or with a counterpart agent executing at sending device 200.

In some implementations, the resource retrieval module 131 may analyze the received application configuration. For example, the resource retrieval module 131 may retrieve one or more application resources based on the respective one or more URLS in the application configuration. In some implementations, the resource retrieval module 131 may also determine a type of the application resource that is retrieved. The types of resources retrieved may include, for example, native code (e.g. DLLs, or Shared Libraries), Virtual Machine byte code, scripts (e.g. JavaScript, Ruby, Python), configuration and UI markup files, and/or other types of resources.

In some implementations, the resource retrieval module 131 may determine of a type of the application resource received by context and/or a MIME type of the data at the resource location. In some implementations, if no context data exists, the resource retrieval module 131 may rely on the MIME type of the data to determine the type of resource. If context data does exist, the resource retrieval module 131 may determine the type of resource based on the specified context. The resource retrieval module 131 may also interpret the data within the specified context (e.g., how to present data to a user, whether to use data at the resource to populate a table). For example, the resource retrieval module 131 may use context to determine that list-type components (e.g., tables, lists, trees, etc.) are to be configured, populated, filtered, and/or searched using or based on data available at a resource. In some implementations, the MIME type of the data can be imposed by the resource retrieval module 131. In some examples, the resource retrieval module 131 may determine a type of the resource based on a specific MIME type associated with the data at the resource, regardless of the conventional associations with that MIME type.

In some implementations, the resource retrieval module 131 may store the resources retrieved, along with at least a type of resource retrieved, at storage module 132. The resources may be associated with a respective application configuration and/or application at the receiving device 100. In some examples, the resources retrieved may also be stored at the storage module 132 with the data at the resources retrieved. In some examples, the resource retrieval module 131 may maintain and/or store at the storage module 132 a set of correlations corresponding to types of resources and known MIME types.

In some examples, as described further below, the assembling module 133 may handle the application resource based on the resource type. In some of these examples, the assembling module 133 may determine the type of the application resource. For example, the assembling module 133 may determine a type of the application resource based on context information and/or MIME type, in a manner similar to that described above with respect to the resource retrieval module 131.

In some examples, the assembling module 133 may determine how to handle the resource based on the resource type. If no context data exists, the assembling module 131 may rely on the MIME type of the data to determine how to handle the resource. If context data does exist, the assembling module 133 may interpret the data within the specified context (e.g., how to present data to a user, whether to use data at the resource to populate a table). For example, the assembling module 133 may use context to determine that list-type components (e.g., tables, lists, trees, etc.) are to be configured, populated, filtered, and/or searched using or based on data available at a resource. In some implementations, the MIME type of the data can be imposed by the assembling module 133. In some examples, the assembling module 133 may determine a type of the resource based on a specific MIME type associated with the data at the resource, regardless of the conventional associations with that MIME type. In some examples, the assembling module 133 may maintain and/or access from the resource retrieval module 131 and/or the storage module 132 a set of correlations corresponding to types of resources and known MIME types. In some of these examples, the assembling module 133 and the RARE engine 110 may facilitate the use of customized application resources and resource types with conventional methods of communication.

In some implementations, the assembling module 133 may include a layout module (not shown). The layout module may format data of a retrieved resource for display via the application. The layout module may access the resources and resource types stored at the storage module 132 and associated with the application configuration and/or application to be assembled and/or rendered. The layout module may also facilitate the preparation and/or rendering of the application for display.

In some implementations, a resource may comprise a plurality of RenderableDataItem entities or data objects that represent data at the resource. The RenderableDataItem object may represent data to be displayed or handled by the application. In some examples, the RenderableDataItem object may include any data in an application resource, including, for example, markup language string, scripts, program code, data for use by the application, and/or other data. In some implementations, the RenderableDataItem objects included in one or more application resources at the one or more repositories 250, 350, 450, and/or at the storage module 132 may be searchable and may be filtered.

In some implementations, the RenderableDataItem object may include one or more attributes which specify that data represented by the object be displayed with one or more features of one or more respective attributes. For example, the RenderableDataItem object may include attributes able to specify one or more features, including, for example, font, color, drag and drop support, column/row spanning, nesting, the use of custom data renderers, and/or other features. For example, using data markup and/or markup language or scripting language, the RenderableDataItem object may specify attributes for a display of data including, for example, width, custom color, graphic icon, color gradient, type, direction, and/or magnitude, and/or other attributes. Gradients may be specified using a comma separated list of colors. A custom color may be derived from another color. For example, a custom color may be indicated as a custom color by specifying a known color and an amount of light to add or remove to the color. The transparency of the known color may also be adjusted.

In some implementations, the RenderableDataItem object may have a plurality of formats. In some examples, the RenderableDataItem object may comprise a comma separated list of values (CSV list). In some implementations, the CSV list may be used when specifying data in columns and/or rows. For example, an individual column of data may be given attributes and/or features using a CSV format. In another example, an individual column of data may be given attributes and/or features using a JSON format.

In some examples, the RenderableDataItem object may comprise markup language. In some implementations, markup language may be used when the data is to be used in complex structures including, for example, complex nested hierarchies, complex fully associative arrays, and other types of complex structures. For example, the markup language may be Rare Markup Language (RML). In some implementations, RML may be specific to systems that include the RARE engine. In other implementations, RML may be widely available and used. RML may be similar to JSON and/or CSS.

In some implementations, the RenderableDataItem object may comprise one or more formats. In some examples, a first RenderableDataItem object may comprise a first format and a second RenderableDataItem object may comprise a second format different from the first format. The type of format of the RenderableDataItem object may depend upon the data represented by the object.

In some implementations, an RML string may be delineated by the use of an identifier (e.g., curly braces). An RML string may include tag-identifier strings, similar to XML strings. In some implementations, an RML string may include variables and functions embedded therein. For example, when parsing an RML string with variables and/or functions embedded therein, the values associated with the respective variables and/or functions may be resolved in the parsing of the RML string. In some examples, an RML string may contain one or more embedded objects, including, for examples, system variables, system functions, resource strings, developer defined attributes, scripting functions, and/or other embedded objects.

A system variable may be an embeddable variable reference that is not specific to the particular instance of the application configuration or application being assembled. For example, a system variable may be a URL that identifies an application resource or an application configuration. A system variable may be identified in an RML string with a unique identifier (e.g., a percent sign).

A system function may one of a set of convenience functions available via the system 10 or available via the sending device 200. In some examples, a convenience function is a non-essential subroutine that eases the execution and/or preparation of commonly-performed tasks or functions in the application. The system function may be provided at or near runtime when assembling the application. A system function may be identified in an RML string with a unique identifier (e.g., a dollar sign prefix).

A resource reference may be a system name for a resource. In some implementations, the resource reference may identify an image or icon. In some implementations, a resource reference may refer to a preloaded string that may be accessed programmatically and/or embedded in an RML string. A resource reference may be identified in an RML string with a unique identifier (e.g., the prefix “resource:”).

A scripting function may also be embedded in an RML string. A scripting function may be a function that may be written in a default scripting language. In some examples, the default scripting language is Javascript. The default scripting language can be any known or usable scripting language or may be a language unique to the RARE engine. Scripting functions may be identified in an RML string with a unique identifier (e.g., two dollar signs).

In some implementations, application level attributes and viewer level attributes may also be embedded in an RML string. For example, references may be resolved from attributes that are configured for a viewer. A viewer may be a special class of widget. A widget maybe a special class of RenderableDataItem. References may be resolved within the context of the viewer. In some examples, references are identified with a unique identifier (e.g., an at sign) that identifies the reference as being an application level attribute rather than a viewer specific attribute. In some examples, other attributes, such as application and viewer attributes) may be configured via an RML string or via program code.

In some implementations, the CSV list may embed single markup language definitions within a column in a CSV list. The markup language may be delineated from other data in the CSV list. For example, the markup language may be within curly braces or another type of identifier or separator that sets the markup language apart. The markup language may be at a beginning or an end of a row and/or a column of data. In some implementations, a hierarchy level for individual rows may be specified within the CSV format. The row may also be prefixed with a number that indicates its level in a hierarchy. The number may be followed with a special delimiter than informs the assembling module and/or layout module that the number comprises information about the row and is not actual data. The use of numbers to indicate hierarchy may facilitate an easier and/or less complicated population of a tree-like structure. In some of these implementations, there may be no embedded markup within the CSV format. For example, the use of the hierarchy level for individual rows and the special delimiter may facilitate the specification of row-level information without the use of embedded markup. The combination of the CSV list and the markup language facilitate the use of the CSV format while being able to provide attributes and/or features for individual rows and/or columns of data within the CSV format.

In some implementations, the RTE module 130 may also include a widget module (not shown). In some implementations, the assembling module 133 may comprise the widget module. In some implementations, the layout module of the assembling module 133 may comprise the widget module. A widget may be an element of a graphical user interface (i.e. an element via which the application is displayed) that displays data in an arrangement that is able to be manipulated by a user. For example, the widget module may be able to assemble and/or render both generic elements (e.g., a text box, a button, a drop-down list, a menu, a toolbar, a link, a window, etc.) as well as application-specific or platform-specific elements (e.g., a biometric input, feature recognition input, etc.). In some implementations, a widget may also be represented by a RenderableDataItem object.

In some implementations, the assembling module 133 may include a markup language parsing module (not shown). In some implementations, the layout module may include the markup language parsing module. The markup language parsing module may be able to parse the markup language included at a resource. For example, the markup language parsing module may be able to analyze a RenderableDataItem object and determine a functionality and/or display for data represented by the object. In some implementations, markup language parsing module may facilitate the rendering of the application based on the resources, RenderableDataItem objects, and other information. For example, the markup language parsing module and/or the layout module may render the application for display based on the resources, RenderableDataItem objects, and other information from the associated application configuration.

In some implementations, the assembling module 133 may also include a skinning module (not shown). In some implementations, the layout module may include the skinning module. In some implementations, the skinning module may use one or more global templates and/or context-specific templates for skinning. A global template may be a UI markup definition, data markup definition, and/or combination of the two. A global template may be preloaded by the assembling module 133 and used to augment later data markup definitions or widgets. In some examples, a global template may exist on the device assembling the application before receiving an associated application configuration. In some examples, one or more global templates may be pre-loaded on a device when the RARE engine is loaded on the device. In some implementations, an application resource may be a global template.

In some examples, an application resource may be a context-specific template. A context-specific template may also be a general application-specific template. The context-specific template may rely on definitions or widgets in a global template that has been pre-loaded or that was pre-existing on the assembling device. For example, the skinning module may determine if an object in a context-specific template is referenced in a global template. If the object is referenced in the global template, then the object in the global template is used to provide a “skin” for the object. In some examples, a global template may provide for a predefined, default skin to be used for an object unless another template provides a specific skin for the object. In some implementations, both global (implicit) skinning and named (explicit) skinning may be used when assembling and/or rendering the application. In some example, when a RenderableDataItem object specifies a “skin” for use, the skinning module may determine whether the “skin” is available. For example, the skinning module may determine whether the RARE engine 110 has access to the skin specified in the RenderableDataItem object. If the “skin” is available, the skinning module may use the specified “skin” for the data represented by the RenderableDataItem object. If the “skin” is not available, the skinning module may use a global “skin” for the data represented by the RenderableDataItem object. If no “skin” is specified and no global “skin” exists, the skinning module may not provide a “skin” for the data represented by the RenderableDataItem object. In some examples, a first piece of data in a widget may be skinned and/or displayed in a manner separate from a second piece of data in that widget. In these examples, the first piece of data may also be associated with one or more markup data objects and/or data attributes. The second piece of data may not be associated with any data objects and/or data attributes, or may be associated with different markup data objects and/or data attributes than the first object.

In some implementations, the assembling module 133 may also include a scripting module 134. The scripting module 134 may provide a scripting environment for use in the application. The scripting module 134 may also execute event handlers and other script code. In some examples, the scripting module 134 may access a script via a URL set forth in the browser-based application. In these examples, the MIME type of the data set forth at the URL may indicate that the resource at the location represented by the URL is a script. The resource retrieval module 131 may retrieve the script from the location represented by the URL. The storage module 132 may store the script. For example, a script storage module (not shown) of the storage module 132 may store the script. The scripting module 134 may be used to load the script after it has been retrieved and stored. In some examples, the scripting module 134 may allow scripts written in different languages to execute and operate as part of a single application. For example, one or more scripting engines may be loaded when assembling the application and/or receiving the application configuration. In some implementations, the scripting module 134 may also have access to native libraries and other resources available on the receiving device 100. For example, the scripting module 134 may have access to all of the native libraries available on the receiving device 100. The scripting module 134 may be connected, via a native bridge, to the native libraries. In some examples, the scripting module 134 may directly access the native libraries of the receiving device 100. In some implementations, native code may exist on the receiving device 100 that may be accessed via the scripting module 134. In some examples, native code existing on the receiving device 100 may access and execute script code.

In some implementations, when an event handler is triggered, a scripting environment may be populated with global objects and/or one or more context-specific objects, such as widgets, forms, and/or windows. The widget may be the widget that triggered the event. The form may be a form containing the widget. A window may be a window of which the widget is included and/or displayed. In some implementations, a widget within the scope of the event may be directly accessible by name. For example, the widget may be considered as a temporary global variable within the scripting environment. In some examples, the widget may be considered as a temporary global variable only while a global variable with the same name is not in scope. For example, for a widget with a name “widgetName” in a form, the value associated with that widget may be accessed, via an event handler triggered by the form or the widget, by using widgetName in the scripting code.

In some implementations, a script may be associated with metadata that indicates characteristics of the script, including, for example, scripting language, compilation properties, accessibility or ability to share the script, and/or other characteristics. In some implementations, scripts may be written in any language for which a scripting engine exists on the device. In some implementations, event handlers may be written in scripting languages for which a scripting engine exists on the device. In some implementations, event handlers must be written in the default scripting language of the RARE engine. In some implementations, the default scripting language is JavaScript. In some implementations, scripts may be attached to a main display window of the application and/or to one or more viewers. For example, a script may be attached to a main display window of the application and/or to one or more viewers via a scriptURL property. The scriptURL property may indicate to which windows and/or viewers a script should be attached. In some implementations, once the script has been stored to the scripting storage, the script may be globally accessible at the device and/or for the application. In some implementations, however, a script may include an identifier that indicates that it will not be shared globally for the device and/or the application.

In some implementations, the scripting module 134 may include a scripting shell module (not shown). In some implementations, the scripting shell module may provide interactive command and control of an assembled application that is running on the receiving device 100. For example, one of the application resources identified in the application configuration associated with the assembled application may be a scripting shell. In some implementations, the assembled application may make an execution of the scripting shell available. When executed, the scripting shell may be used to test and/or debug the assembled application.

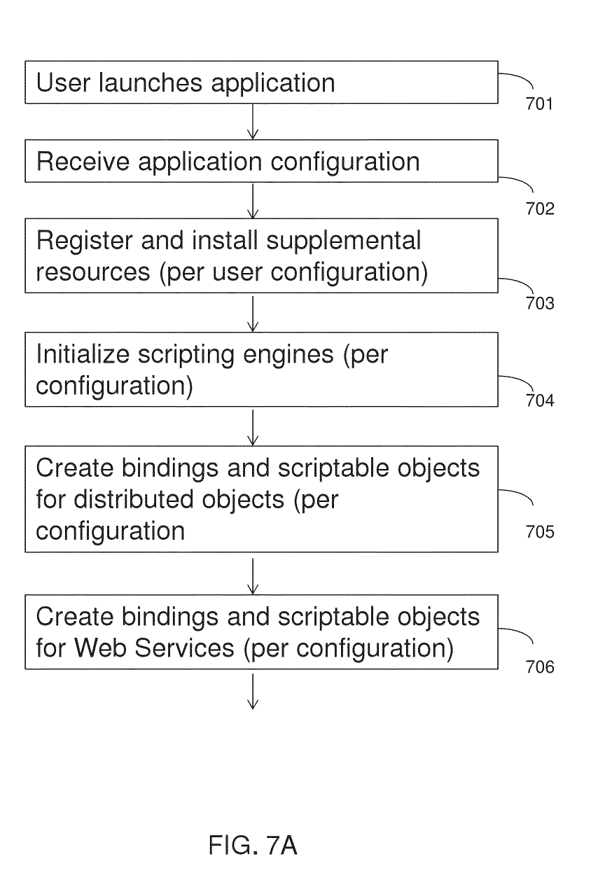

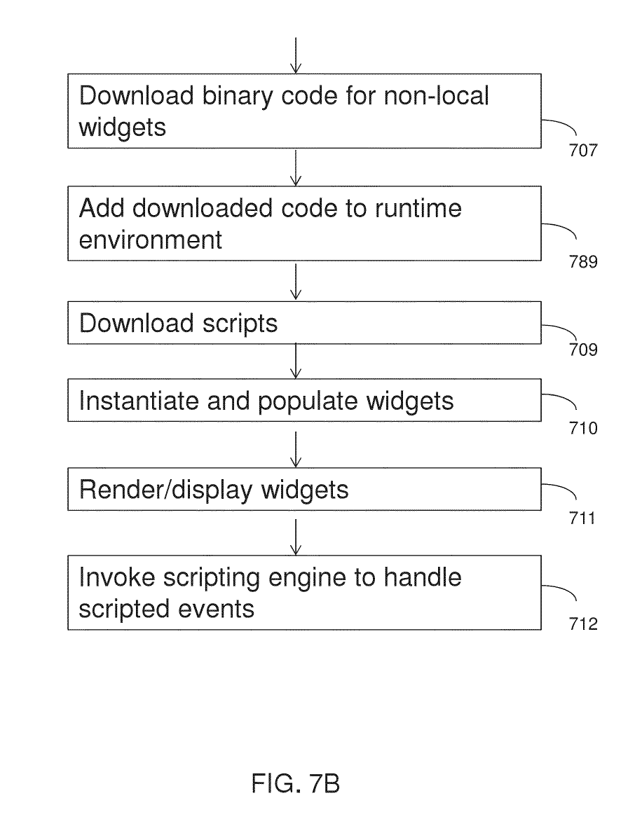

In some implementations, the assembling module 133 may assemble resources in a specific order. In some examples, the assembling module 133 may assemble resources based on type of resource. The resources may be assembled in an order in which the resources may be used during runtime of the application. As discussed below with respect to FIGS. 7A and 7B, the application resources identified in the application configuration may be accessed and/or used in a specific and/or predetermined order. In some examples, the assembling module 133 may organize the access and assembling of resources according to the order in which the resources may be accessed or used by the runtime environment. In some examples, one of the application resources identified in the application configuration may set forth an order for assembling the resources. In some examples, the assembling module 133 may access a default order for assembling the resources if no other order is provided. The default order may be stored at storage module 132.

In some implementations, the RTE module 130 may augment or replace prebuilt components, interactions, and resources of the RTE at or near runtime. In some implementations, the RTE module 130 has certain built-in features. For example, the RTE module 130 may include one or more built-in components, interactions, resources, and/or other built-in features that it may use when assembling an application based on an application configuration. In some examples, the application configuration may specify replacements for one or more of the built-in features. For example, the RTE module 130 may have a built-in image viewer that it may use when an image viewer is needed. In some examples, an application configuration may specify an alternate viewer to be used as the default viewer for the application. For example, the application configuration may include a URL identifying a location at which code for the alternate viewer may be available. The code for the alternative viewer may be a resource that may be retrieved and assembled as part of the application at or near run-time.

In some implementations, one of the resources retrieved may include code that accesses the native resources of the device to obtain information relating to the device or the user of the device. In another example, one of the retrieved resources may be a script that accesses native resources and/or native libraries of the device to obtain information relating to the device or the user of the device. The assembling module 133 and/or the scripting module 134 may execute the code (or script) during a runtime of the assembled application. The assembling module 133 may include information relating to the device in assembling the application. For example, the assembling module 133 may assemble the application based on any criteria that the application provider chooses, including, for example, user preferences, device characteristics, security constraints, user's physical location, user's language, and other criteria.

In some implementations, the RTE module 130 may also include an execution module 136. The execution module 136 may execute the assembled application. The execution module 136 may interact with the network module 120 to make the assembled application available for use. In some implementations, an execution module 136 is not used. Rather, in some examples, the browser functionality of the network module 120 along with the assembling module 133 facilitates the execution of the application.

In some implementations, the RTE module 130 may include a web proxy module 135 and/or a URL rewriting module (not shown). These modules may manage session cookies and other HTTP state/security information. These modules may also make the session cookies and other state/security information available to external components. For example, the web proxy module 135 and URL rewriting module may make session cookies and HTTP state/security information available to external components that may want web access to secured application resources.

In some implementations, the web proxy 135 and/or URL rewriting modules may facilitate communication of session information and/or other HTTP state/security information to one or more external components. In some examples, when an application displays information via an external component, the RTE module 130 may use the URL rewriting module to create a special URL that points to the web proxy module. For example, the application may include security measures to provide for authorized user access. An application user may have to provide credentials to access the application and/or application functionality. When the application displays information via an external component, the application may have to send the external component a URL to launch. In some examples, the URL may not be publicly accessible. In some examples, the user credentials may also not be publicly accessible. The RTE module 130 may send the external application a special URL created by the URL rewriting module. The special URL may point to the web proxy module 135. The RTE module 130 may launch the external component with the special URL. The web proxy module 135 may then use the resource retrieval module 131 to retrieve a resource at the original URL. The web proxy module 135 and/or the resource retrieval module may send the retrieved resource to the external application. The external component may then use the resource. For example, the external component may display the information from the application. In some examples, an external component may include one or more an external browser, a PDF viewer, a movie player, and/or other external components. In some implementations, the web proxy module 135 may be a web proxy server. In some implementations, the web proxy module 135 may facilitate the retrieval of secure information. For example, the web proxy module 135 may facilitate the retrieval of secure information for an external component as described above. In another example, the web proxy module 135 may facilitate the retrieval of secure information for a native component of computing device 100. For example, the web proxy module 135 may facilitate retrieval of secure information for a native library of computing device 100. In some examples, when the assembled application displays a PDF that requires security credentials for access, the RTE module 130 may invoke an external PDF viewer with a URL that points to the web proxy module 135 as discussed above. The web proxy module 135 and/or resource retrieval module 131 may retrieve the PDF using the user's security credentials and facilitate access of the PDF to a native PDF viewer on computing device 100.

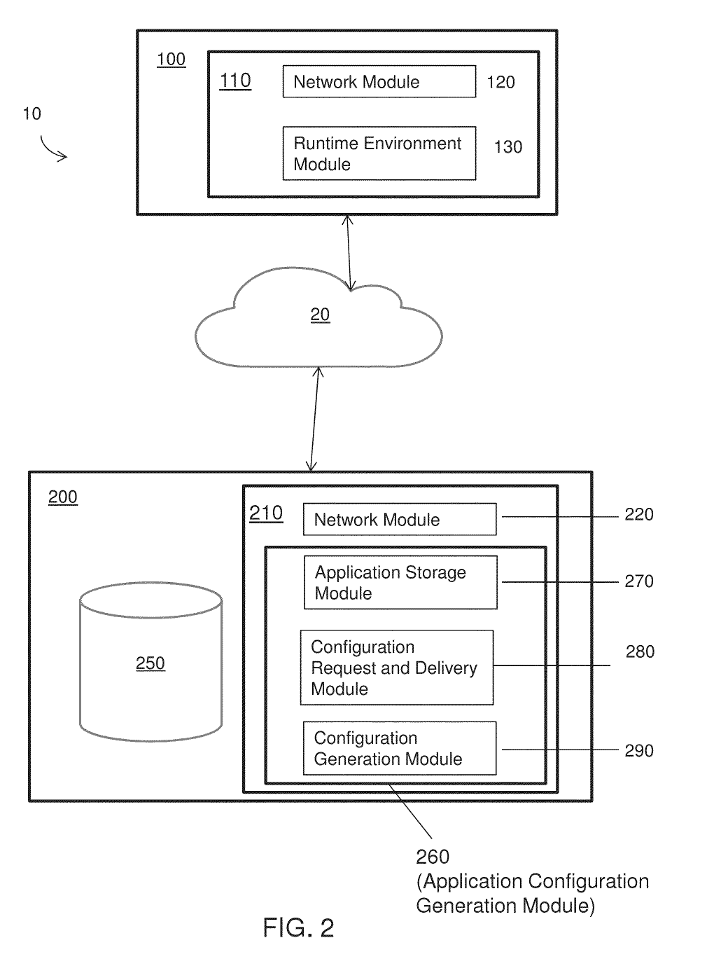

In the example system shown in FIG. 2, the sending device 200 includes a RARE engine 210. RARE engine 210 may include some features similar to the RARE engine 110 described with respect to FIG. 1.

In some implementations, sending device 200 may also include an application configuration generation module 260. The application configuration generation module 260 may include a plurality of modules including, for example, an application storage module 270, a profile storage module (not shown), a configuration request and delivery module 280, a configuration generation module 290, and/or other modules.

In some implementations, application storage module 270 may comprise a plurality of applications available at sending device 200. The application storage module 270 may also comprise a plurality of resources associated with a stored application. For example, for a stored application, application storage module 270 may store a set of resources necessary for the application to be executed and a set of resources that are optional to the application. These optional resources may provide features including, for example, additional functionality, more versatile display, increased user interactivity, and/or other features. In some implementations, application storage module 270 may store identifiers for the required and optional resources associated with the application. For example, application storage module 270 may store a URL identifying a location of the resource. For example, the URL may identify a memory address at which the resource may be stored at a computing device. In another example, application storage module 270 may store an address corresponding to a location in a memory of the second computing device at which the resource may be stored. The memory may be, for example, part of or separate from the application storage module 270. In some examples, the memory may reside on a separate device. In some examples, the memory may reside at one or more of repositories 250, 350, 450.

In some examples, for a resource associated with the application, one or more sets of resources may be stored. The set of resources may comprise resources including one or more different ways of providing a same or similar functionality. For example, a resource may be program code to be included in the application. One way of providing the program code would be to provide program code in a first language. Another way of providing program code would be to provide the program code in a second language different from the first language. Another way of providing program code would be to provide a script in a first language that provides the functionality of the program code. One or more ways of providing the resource may be associated with a resource in the application storage module. Application storage module 270 may also store the features or differences between the ways of providing the resource along with the association to the resource.

In some implementations, resources may be generated and/or modified by other resources that were stored at the application storage module 270. In some implementations, a resource may be generated at a memory address of the application storage module 270. In some examples, a URL may be created that identifies the memory address of the generated resource. In some examples, the created URL may be a resource in the application storage module 270 as well.

In some examples, a resource associated with the application may be augmented with additional functionality and/or features based on information included in the application request. For example, a resource may be augmented with a RenderableDataItem object that contains attributes regarding the display of data at the resource. In another example, the resource may be tied to a context-specific or global template. In some examples, a resource may be linked to a second resource. The second resource may or may not be associated with the application to be assembled. The second resource may provide additional functionality and/or features for the resource associated with the application.

In some implementations, the profile storage (not shown) may store profile information for a user and/or profile information for a device. In some implementations, a user may be associated with a device. The user profile information may include user information and user preferences associated with the user. The user information may include, for example, user name, user email address, user devices, IP addresses associated with the user, a user identifier (e.g., a name, number, or other type of identifier), and/or other user information. The user preferences may include, for example, display preferences, interactivity preferences, security preferences, physical location, language preferences, and/or other preferences. The device profile information may include device information and/or device constraints. The device information may include, for example, a type of the device, a user associated with the device, an IP address associated with the device, device capabilities, and/or other device information. The device constraints may include, for example, accepted coding languages, accepted script types and/or languages, display and/or format constraints, libraries or resources native to the device, product delivered (e.g., application or application configuration) and/or other constraints. In some implementations, the profile storage resides at a same memory or set of memories as the application resources and/or the applications.

In some implementations, configuration request and delivery module 280 may be configured to receive one or more requests for one or more respective applications from one or more computing devices. The configuration request and delivery module 280 may also be configured to facilitate the delivery of an application configuration to a computing device based on a request received from the computing device. In some implementations, the request comprises at least an application identifier and a location identifier to which the application should be delivered. The request may also comprise user information and/or device information. In some examples, the request may comprise constraints or preferences regarding the application. The request may also specify whether to prepare an application configuration or prepare an assembled and/or renderable application. The configuration request and delivery module 280 may store the request in the application storage module 270 and/or the profile storage module. The configuration request and delivery module 280 may also facilitate access of the request to the configuration generation module 290. When the configuration generation module 290 has prepared an application configuration, the configuration request and delivery module 280 may deliver that application configuration to the requesting computing device and/or the IP address specified in the request.

In some implementations, the configuration generation module 290 prepares an application configuration based on a request received via the configuration request and delivery module 280. The configuration generation module 290 may prepare the application configuration based on any information included in the request. The request may include information regarding one or more of, the application requested user information, profile information, constraints, preferences, device type, developer supplied scripting logic, and/or other information included in the request. In some examples, the configuration generation module 290 may access resources for the application based on the request information by choosing the optimal resources available to provide application functionality.

In some implementations, the configuration generation module 290 may access a metadata of a resource to determine if it is an optimal resource given the information in the application configuration request. For example, the application storage module 270 may comprise a set of resources associated with a necessary resource. The set of resources may include alternative resources (markup, scripts, images, etc.) that may be used for different languages, different devices, and/or different platforms, among others. The configuration generation module 290 may compare meta-information associated with the set of resources with the information in the request (e.g., device type, language, screen resolution and density, OS, platform, IP address, etc.) to determine the optimal resources available.

In some examples, the configuration generation module 290 may access resources for the application based on the necessary resources for that application and based on available optional resources that coincide with information in the request. For example, for a necessary resource, the configuration generation module 290 may access a specific resource identified as part of a set of resources that provide the functionality of the necessary resource. The specific resource may be chosen from the set of resources based on the request information. In some implementations, the characteristics of a set of resources providing a same or similar functionality including, for example, features that differentiate a resource and functionality of the resource, may be searchable by the configuration generation module 290. The configuration generation module 290 may also be able to filter resources based on the request information. In some examples, the configuration generation module 290 may select resources to be assembled for the application using search or filtering functionality. As discussed above, the configuration generation module 290 may include location identifiers to the accessed and/or selected resources in the application configuration.

In some examples, an application configuration generated by the configuration generation module 290 based on a request for an application from a phone would be different from an application generation based on a request for the same application from a tablet. Similarly, the application configuration generated based on a request for the same application coming from a laptop or desktop may be different. In some examples, the configuration generation module 290 may prepare an application configuration based on specifications of the device and/or developer supplied scripting logic included in the request.

In some examples, a location of the device to which the application configuration is to be sent may also generate a different application configuration. For example, an application configuration generated based on a request for an application to be sent to a device at location A may be different than an application configuration generated based on a request for the same application for the same device at location B. In another example, an application configuration for an application may be generated based on the location of the device to which the application is to be delivered. For example, for a medical application designed to allow a physician to access a patient record, the application configuration may be generated only if the physician is in a hospital or clinic in which the patient is located. In some examples, an IP address associated with the physician may be used to determine location. In some examples, GPS signals may be used to locate a physician and a physician's known patients. In some examples, a proximity of a device associated with the physician to an RFID tag associated with the user may be used to determine which patient record to access. In another example, the application configuration may be generated based on the patient with the closest physical proximity to the physician (based on the patient's associated RFID tags). In other examples, if a location of a device indicates that it is not using a known network, the application configuration may be configured to request additional authorization from a user of the device and to restrict information that is provided to the device and/or the user. In another example, an application configuration generated for an application based on a request from a cardiologist may be different than an application configuration generated for the same application based on a request for a radiologist due to the respective requests including information regarding practice specialty. Any number of criteria can be included in the request for the application. The information that may be included in the request is not limited to the examples described herein.

In some implementations, the configuration generation module 290 may prepare an application configuration and/or an application for execution based on the received request. The configuration generation module 290 may include the accessed and/or selected location identifiers in an application configuration. In some examples, the configuration generation module 290 may assemble the application based on the identified resources and may prepare and/or render the application for display and/or execution. The application may be similar to an application assembled by the RARE engine based on an application configuration. In some examples, the application may be handled by the RARE engine 110 at the receiving device 100. For example, the application may run using the RARE engine 110 at the receiving device 100. The application may be prepared, like an application assembled by the RARE engine, based on the native resources and capabilities of the receiving device 100.

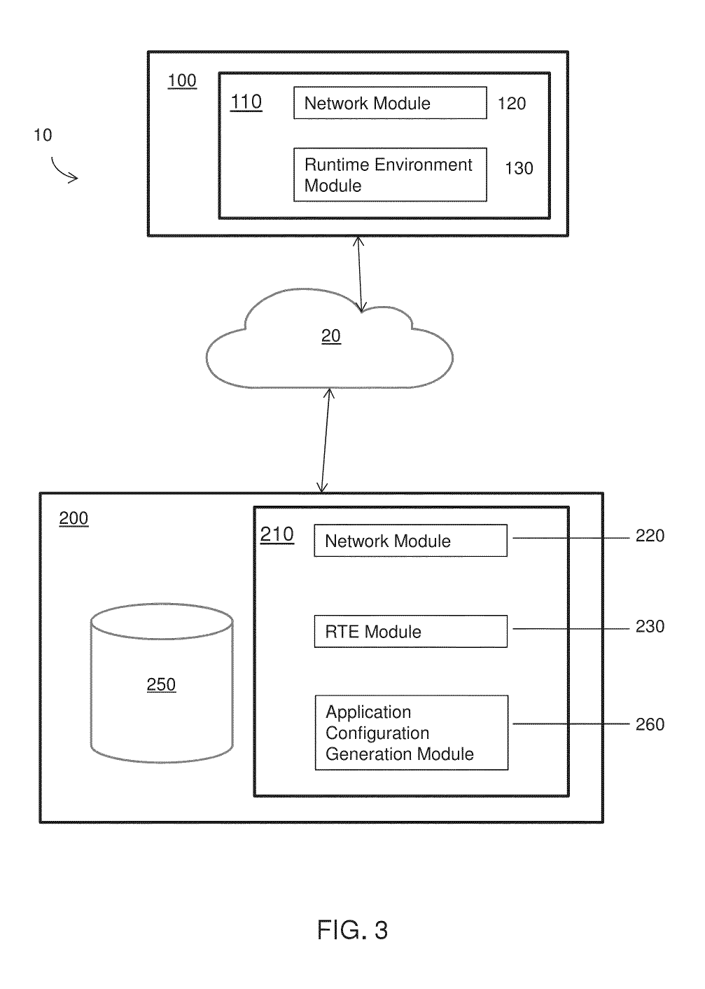

In the example system shown in FIG. 3, the sending device 200 includes a RARE engine 210 similar to the RARE engine 110 described with respect to FIG. 1 and an application configuration generation module 260 similar to the application configuration generation module 260 described with respect to FIG. 2.

In some implementations, the application may exist entirely on the file system of the receiving device 100 and run like any other native application. In some implementations, the application may exist entirely in a cloud-based environment. In some examples, the sending device 200 may be a device at the cloud-based environment. In some of these examples, the RARE engine 210 of the sending device 200 will download the markup, images, script code, and any supplemental libraries, and assemble the application in near real-time. Network latency may be the only difference in startup time between local and cloud hosted applications. In some implementations, the application may be run from a local copy on receiving device 100 and may transition to a cloud-based version of the application running on sending device 200 if a user of the application is connected to a network and/or the cloud.

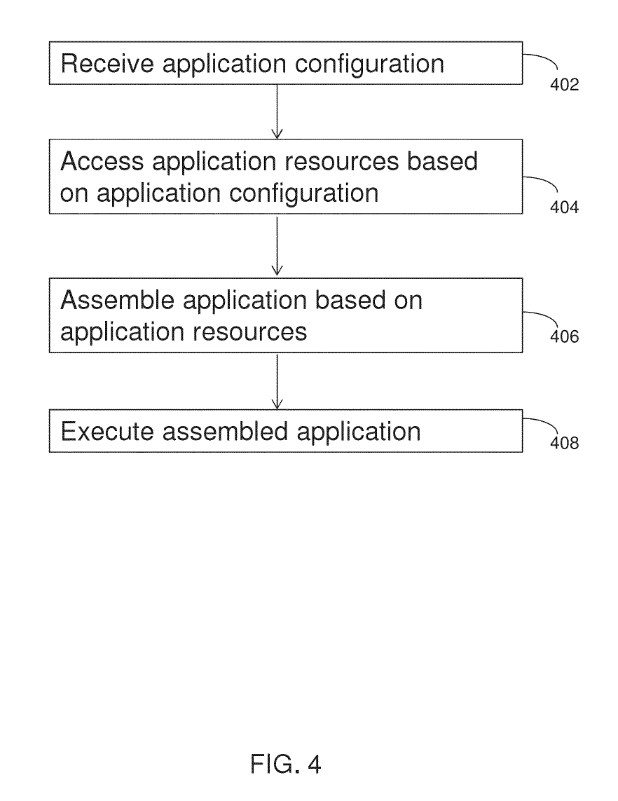

FIG. 4 illustrates a process 400 for dynamically assembling an application for execution on a first device from a platform-independent application configuration, according to various implementations of the invention. The described operations of FIG. 4 and other drawing figures may be accomplished using some or all of the system components described in detail above and, in some implementations, various operations may be performed in different sequences. In other implementations, additional operations may be performed along with some or all of the operations shown in FIG. 4 and the other drawing figures. In yet other implementations, one or more operations may be performed simultaneously. In yet other implementations, one or more combinations of various operations may be performed. Some implementations may not perform all of the operations described with relation to FIG. 4 and other drawing figures. Accordingly, the operations described are exemplary in nature and, as such, should not be viewed as limiting.

In an operation 402, the receiving device 100 receives an application configuration. The receiving device 100 may receive the application configuration from a sending device 100 in response to a request to launch an associated application. In other examples, the receiving device 100 may receive the application configuration from another source and may access the application configuration in response to a request to launch the associated application.

In operation 404, the receiving device 100 accesses the resources identified in the application configuration are accessed. In some examples, the resource retrieval module 131 of the RTE module 130 of a RARE engine 110 residing on the receiving device 100 accesses the identified resources. For example, the resource retrieval module 131 may retrieve the application resources from locations identified in the application configuration. In some implementations, the resource retrieval module 131 may store the retrieved and/or accessed resources at storage module 132.

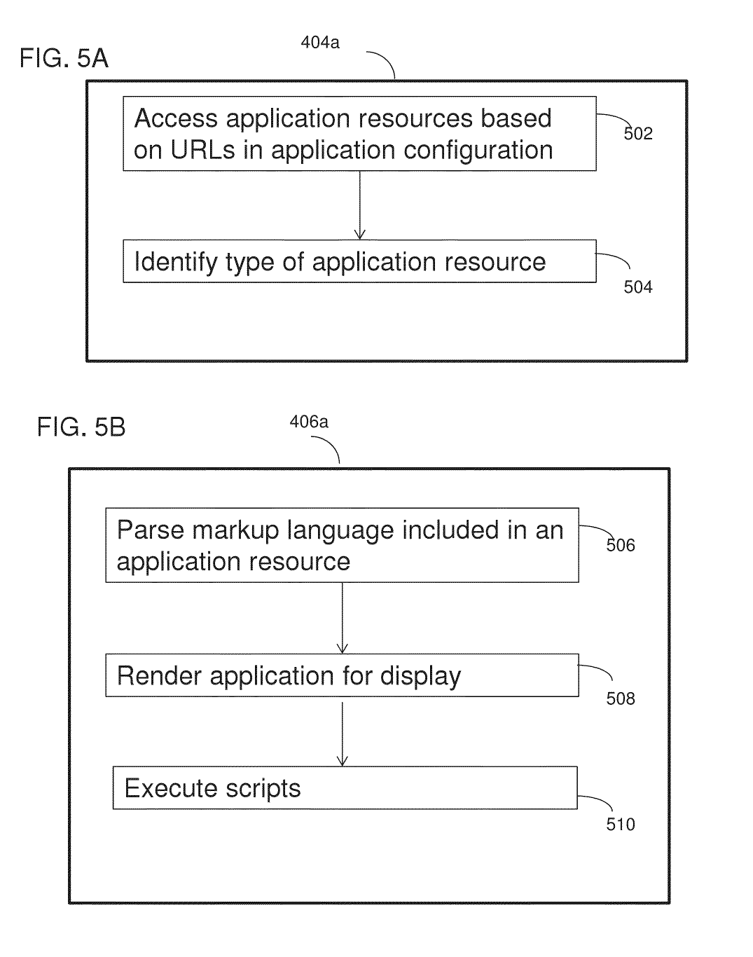

In some implementations, as illustrated in FIG. 5A, the resource retrieval module 130 may retrieve the application resource from respective URLs included in the application configuration (operation 502). The resource retrieval module 131 and/or assembling module 133 may identify, for the retrieved resources, a type of the application resource in a manner similar to that discussed above (operation 504).

In an operation 406, the assembling module 133 of the RTE module 130 may assemble the application for execution based on the application resources. The assembling module 133 may assemble the application resources and may provide layout and scripting functionality for the application. In some implementations, as illustrated in FIG. 5B, the assembling module 133 may parse markup language in an application resource (operation 506). For example, a markup language parsing module may parse RML strings included in one or more application resources identified in the associated application configuration. The layout module of the assembling module 133 may prepare and/or render the application for display based upon the parsed markup language and other application resources. The scripting module 134 may prepare scripts included in one or more application resources identified in the associated application configuration. For example, scripting module 134 may launch one or more scripting engines and prepare any accessed scripts for execution.

In an operation 408, the receiving device 100 may execute the assembled at the device 100. For example, the RARE engine 110 may provide information including, for example, application resources, parsed markup language, display objects, scripts, program code, and/or other information for execution by the receiving device 100. In some implementations, a browser at the receiving device 100 may execute the application in a manner similar to its execution of other applications. The browser may access the information provided by the RARE engine 110 when executing the application.

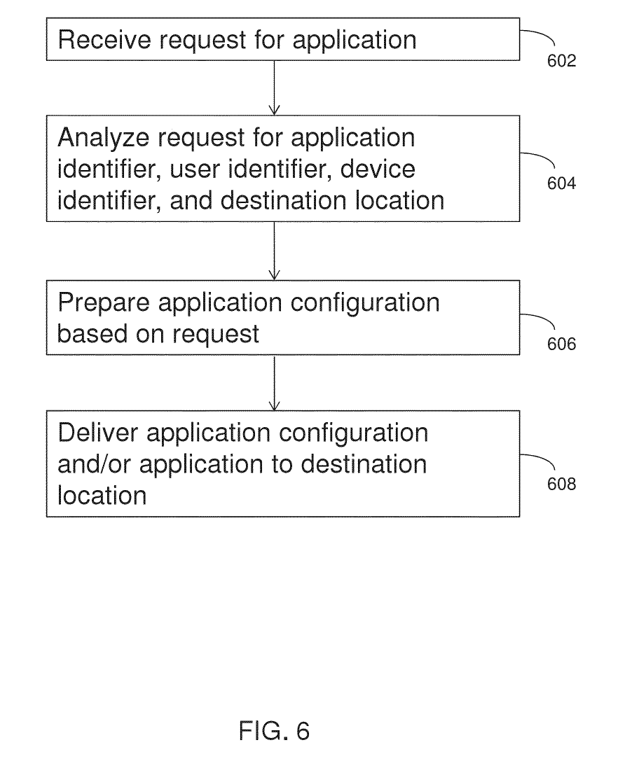

FIG. 6 illustrates a process for preparing an application configuration for an application, according to various implementations of the invention.

In an operation 602, the sending device 200 receives a request for an application. For example, a configuration request and delivery module 280 may receive a request for an application. The request may come from receiving device 100. In some implementations, the request may be automatically generated by the sending device 200 when a new application is stored in application storage module 270. In these implementations, the application configuration may include a generic application configuration. In some examples, application resources may be stored in the application storage based on the user profile, device profile, and other constraints that may be identified with other applications.

In an operation 604, the configuration request and delivery module 280 and/or configuration generation module 290 may analyze the request. For example, the request may be analyzed to determine if it contains request information including, for example, an application identifier, user identifier, device identifier, device display metrics, location identifier, constraints, and/or other information.

In an operation 606, the configuration generation module 290 of the sending device 200 may prepare an application configuration based on the application request, in a manner similar to that described above. In some implementations, the configuration generation module 290 may also assemble and/or render an application for execution based on the application configuration.

In an operation 608, the configuration request and delivery module 280 of the sending device 200 facilitates delivery of the application and/or application configuration. For example, the configuration request and delivery module 280 may send the application and/or application configuration to a location identified in the application request. Alternatively, the configuration request and delivery module 280 may store the application and/or application configuration on a removable disk that may be transported to a location at which the application and/or application configuration may be used. In another example, the configuration request and delivery module 280 may store the application and/or application configuration in a repository (e.g., repositories 250, 350, 450) that are accessible to a destination device. Other methods of facilitating delivery of the application and/or application configuration may be used as well.

FIGS. 7A and 7B illustrate a flow chart for launching an application using an application configuration, according to an implementation of the invention.

In some implementations, in operation 701, a user launches an application on receiving device 100.

In operation 702, the receiving device 100 accesses an application configuration associated with the application to be launched. The receiving device 100 may access the application configuration in a manner similar to that described above.

In operation 703, the receiving device 100 may access and install supplemental resources, based on the application configuration. In this operation, the receiving device 100 may access application resources from the application configuration and store them at the receiving device 100 in a manner similar to that described above. For example, resource retrieval module 131 may access application resources and store them at storage module 132 in a manner similar to that described above.

In operation 704, the receiving device 100 may initialize scripting engines based on one or more scripts included in the supplemental resources. For example, the scripting module 134 may launch scripting engines based on scripts included in the accessed application resources in a manner similar to that described above.

In operation 705, the receiving device 100 may create bindings and scriptable objects based on the application resources included in the application configuration. For example, for scripts and/or objects that may be global to the application, the scripting module 134 and/or the assembling module 133 may create bindings and scriptable objects. The bindings and/or scriptable objects may be stored at storage module 132 and may be accessed by the assembled application and/or the components associated with running the application. In some implementations, storage module 132 may comprise one or more component libraries (not shown). A component library may be configured to provide support for user interface objects and interactions. The component library may store the bindings and scriptable objects based on the application resources included in the application configuration. In some examples, the component library 832 may be configured to provide support for one or more user interface metaphors and interactions. For example, the supported user interface metaphors and interactions may include one or more of tables, lists, document editing, drag and drop, printing, and/or other user interface metaphors and interactions.

In operation 706, the receiving device 100 may create bindings and scriptable objects based on the application resources included in the application configuration. For example, for scripts and/or objects that may be used for Web Services, the scripting module 134 and/or the assembling module 133 may create bindings and scriptable objects. Web Services may include methods by which the assembled application communicates with other devices and/or resources over the network 20. In some examples, the web proxy module and/or URL rewriting module may create bindings and scriptable objects. The bindings and/or scriptable objects may be stored at storage module 132 and may be accessed by the assembled application and/or the components associated with running the application.

In operation 707, the receiving device 100 may download binary code for non-local widgets. In some examples, the receiving device 100 may access an application resource identified in the application configuration that includes code for the non-local widgets. In other examples, the receiving device 100 may access binary code from an external component via network 20.

In operation 708, the receiving device 100 may add the downloaded code to the runtime environment. In some examples, the assembling module 133 of the RARE engine 110 may assemble the code for use in the runtime environment for the application.

In operation 709, the scripts for use in the application may be downloaded. For example, resource retrieval module 131 may access one or more application resources that include the scripts.

In operation 710, widgets for the application may be instantiated and populated. For example, the layout module and/or the widget module of the assembling module 133 may instantiate and/or populate the widgets in a manner similar to that described above.

In operation 711, the widgets may be rendered and/or displayed. For example, assembling module 133 and/or execution module 136 may render and/or display the widgets during the running of the application in a manner similar to that described above.

In operation 712, one or more scripting engines may be invoked to handle events. For example, scripting module 134 may launch one or more scripting engines to recognize and/or handle events when an event may be triggered.

In some implementations, operations 707 to 712 may begin at a same time as operations 701 to 706. In some embodiments, operations 707 to 712 may also include conventional browser functionality that utilizes data and information from the application resources to run the application. In some implementations, operations 711 and 712 may occur after or during running of the application.

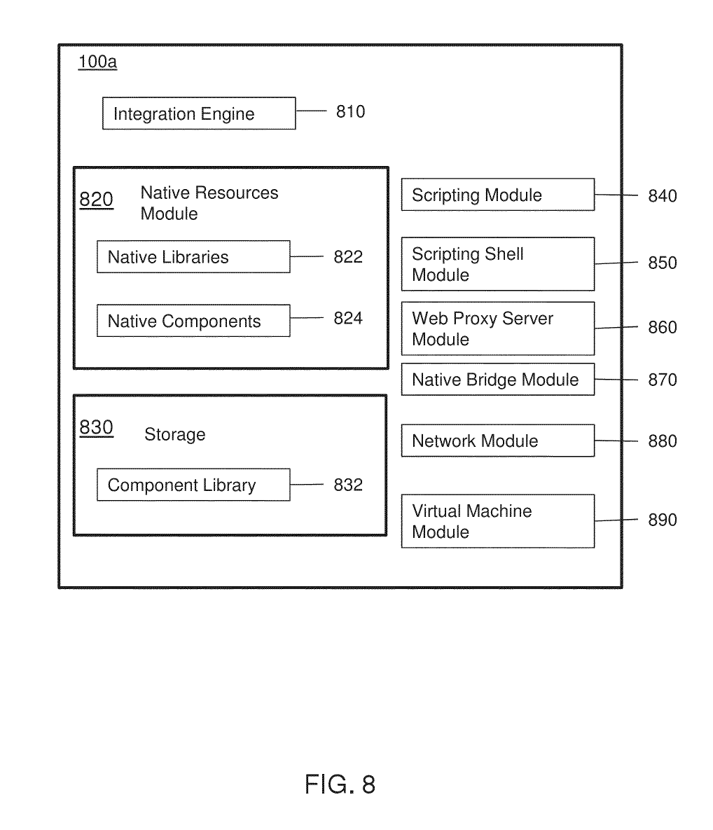

FIG. 8 illustrates an exemplary diagram of a receiving device 100a for dynamically assembling an application (not shown), according to an implementation of the invention. The receiving device 100a may receive an application configuration. The application configuration may be related to an application to be launched at the receiving device 100a. The receiving device 100a may access, based on the application configuration, application resources. The receiving device 100a may use the application resources to dynamically assemble an application relating to the application configuration. The receiving device 100a may include a RARE engine and one or more computing modules. For example, the receiving device 100a may include an integration engine 810, native resources 820, storage 830, a scripting module 840, a scripting shell 750, a web proxy server 860, a native bridge 870, a network module 880, a virtual machine 890, and/or other computing modules.

In some implementations, the integration engine 810 may be configured to integrate and manage components and interactions of the application. For example, the integration engine 810 may be configured to assemble the application based on resources identified in the application configuration. In some implementations, integration engine 810 may correlate to one or more of the resource retrieval module and assembling module of receiving device 100. For example, integration engine 810 may perform all or some of the functionality of resource retrieval module 131 and assembling module 133.

In some implementations, native resources module 820 may comprise resources native to the receiving device 100a. For example, native resources module 820 may comprise native libraries 822 and native components 824. In some implementations, integration engine 810 and/or scripting module 840 may access the native resources module 820 when assembling the application.

In some implementations, storage 830 may comprise data that supports assembling and/or running an application. For example, storage 830 may include one or more component libraries 832. A component library 832 may be configured to provide support for user interface objects and interactions. For example, component library 832 may provide functionality similar to the layout module and the widget module of the assembling module 133. In some examples, the component library 832 may be configured to provide support for one or more user interface metaphors and interactions. For example, the supported user interface metaphors and interactions may include one or more of tables, lists, document editing, drag and drop, printing, and/or other user interface metaphors and interactions.

In some implementations, scripting module 840 may provide support for executing scripts. For example, scripting module 840 may launch on or more scripting engines. Scripting module 840 may also execute downloaded scripts and event handlers. For example, scripting module 840 may provide functionality similar to scripting module 134.

In some implementations, scripting shell module 850 may provide testing and debugging functionality for an application. For example, scripting shell module 850 may provide interactive command and/or control of a running application for testing and/or debugging the running application. In some examples, scripting shell module 850 may provide functionality similar to the scripting shell module of the scripting module 134.

In some implementations web proxy server module 860 may provide web access to native components. For example, the web proxy server may enable the integration engine 810 to manage security and session information. In some examples, the web proxy server module 860 may facilitate management of security and session information for both native resources 820 and the RARE engine. In some examples, web proxy server module 860 may provide functionality similar to the web proxy module 135 and/or URL rewriting module.

In some implementations, native bridge module 870 may provide access to native resources. For example, native bridge module 870 may allow access to native resources 820 for scripts executed by scripting module 840. In some examples, native resources module 820 may access scripts executed by scripting module 840. For example, native resources module 820 may access script code executed by scripting module 840. The native bridge module 870 may provide functionality similar to one or more of the assembling module 133 and the scripting module 134.

In some implementations, network module 880 may facilitate communication with other devices. In some examples, network module 880 may provide functionality similar to network module 120.

In some implementations, virtual machine module 890 may facilitate the generation of a virtual machine on receiving device 100a. For example, the virtual machine module 890 may facilitate a software implementation of an operating system that is able to execute one or more applications. In some implementations, virtual machine module 980 may run an application assembled by the RARE engine and receiving device 100a. In some implementations, the RARE engine may run on a virtual machine generated by virtual machine module 890. In some implementations, the RARE engine may run on a virtual machine that already exists on the device.

In some implementations, the functionality and/or components of receiving device 100 and receiving device 100a may be interchangeable. In some implementations, the capabilities of receiving device 100 and receiving device 100a may be the same or similar. In some implementations, receiving device 100 and receiving device 100a may be interchangeable in a system. For example, in exemplary system 10, as depicted in FIG. 1, receiving device 100 may be replaceable by receiving device 100a.

The receiving device 100, 100a may be any computing device such as, for example, a server, a desktop computer, laptop computer, personal digital assistant, smart phone, and/or any other computing device. Other configurations and system architectures may be used. For example, although not shown, receiving device 100, 100a may be or include one or more servers connected to one or more clients via a network 20 such as a Wide Area Network, Local Area Network, the Internet, a cloud-based network and/or other network or combination thereof. The receiving device 100, 100a may be capable of communicating with network 20, sending device 200, and/or repositories 250, 350, 450.

In some implementations, the receiving device 100, 100a communicates with sending device 200 without the use of intermediary user devices or clients (i.e. directly through a network). In some implementations, receiving device 100, 100a communicates with sending device 200 via the use of an intermediary. In some implementations, receiving device 100, 100a communicates with sending device 200 via the network 20. In some implementations, the receiving device 100, 100a is able to communicate with sending device 200 over the Internet and/or without communicating via network 20 or a part of network 20.

The sending device 200 may be any computing device such as, for example, a server, a desktop computer, laptop computer, personal digital assistant, smart phone, and/or any other computing device. The sending device 200 may be capable of communicating with network 20, receiving device 100, 100a, repositories 250, 350, 450, and/or other devices connected at network 20.

The one or more repositories 250, 350, 450 comprising the application resources 240a-n, 340a-n, 440a-n, may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method for assembling an application on a computing device, comprising:
receiving, by a network module of the device, an application configuration;
retrieving, by a run-time environment module of the device, one or more application resources identified in the application configuration;
storing, at a storage coupled to the run-time environment module, the one or more application resources; and
assembling, by an assembling module of the run-time environment module, the application based on the one or more application resources.

2. The method of claim 1, further comprising:
executing, by an execution module, the assembled application.

3. The method of claim 1, further comprising:
retrieving, by the run-time environment module of the device, the one or more application resources based on one or more respective URLs identified in the application configuration.

4. The method of claim 3, further comprising:
identifying, by the run-time environment module of the device, a type of one of the one or more application resources based on a type identifier associated with the respective URL in the application configuration.

5. The method of claim 4, wherein a type of the one or more application resources comprises one of: a data resource, a library resource, a script resource, a formatting resource, or a preloaded resource.

6. The method of claim 1, wherein at least one of the one or more application resources comprises a library resource, the method further comprising:
storing, at a component library included in the storage, the at least one library resource.

7. The method of claim 6, wherein the at least one library resource comprises an environment-specific repository including one or more of: a resource, a script, or a user interface markup.

8. The method of claim 1, further comprising:
preparing, by a layout module included in the assembling module, the application for display at a user interface of the computing device.

9. The method of claim 8, wherein one of the one or more application resources is a formatting resource, the method further comprising:
parsing, by a markup language rendering module included in the layout module, markup language included in the formatting resource; and
rendering, by the assembling module, a display based on the markup language.

10. The method of claim 1, wherein one of the one or more application resources is a scripting resource, the method further comprising:
executing, by a scripting module included in assembling module, one or more scripts including in the scripting resource.

11. The method of claim 10, further comprising:
executing, by the scripting module, a first script of a first language and a second script of a second language different from the first language.

12. The method of claim 10, further comprising:
providing, by a native bridge of the computing device, access for the RTE module to native libraries.

13. The method of claim 12, further comprising:
allowing, by the RTE module, one or more native libraries to access script code.

14. The method of claim 10, further comprising:
testing, by a scripting shell module included in the scripting module, the assembled application.

15. The method of claim 1, further comprising:
managing, by a web proxy module, security and session information of the assembled application that can be shared with one or more native libraries/components.

16. A computing device including an application rendering engine for dynamically assembling an application, the device comprising:
a network module configured to receive an application configuration; and
a run-time environment (RTE) module comprising:
a resource retrieval module configured to retrieve one or more application resources identified in the application configuration;
a storage for storing the one or more application resources; and
an assembling module configured to assemble the application based on the one or more application resources.

17. The device of claim 16, further comprising:
an execution module configured to execute the assembled application.

18. The device of claim 16, wherein the resource retrieval module is further configured to retrieve the one or more application resources based on one or more respective URLs identified in the application configuration.

19. The device of claim 16, wherein the resource retrieval module is further configured to identify a type of one of the one or more application resources based on a type identifier associated with the respective URL in the application configuration.

20. The device of claim 19, wherein a type of the one or more application resources comprises one of: a data resource, a library resource, a script resource, a formatting resource, or a RTE resource.

21. The device of claim 16, wherein at least one of the one or more application resources comprises at least one library resource, and wherein the storage further comprises a component library configured to store the at least one library resource

22. The device of claim 21, wherein the at least one library resource comprises an environment-specific repository including one or more of: a resource, a script, or a user interface markup.

23. The device of claim 22, further comprising:
a layout module included in the assemble module, the layout module configured to prepare the application for display at a user interface of the computing device.

24. The device of claim 16, wherein one of the one or more application resources is a formatting resource, the engine further comprising:
a markup language rendering module included in the layout module, the markup configured to:
parse markup language included in the formatting resource; and
render a display based on the markup language.

25. The device of claim 16, wherein one of the one or more application resources is a scripting resource, the engine further comprising:
a scripting module included in the assembling module, the scripting module configured to execute one or more scripts including in the scripting resource.

26. The device of claim 25, wherein the scripting module is further configured to execute a first script of a first language and a second script of a second language different from the first language.

27. The device of claim 25, further comprising:
a native bridge configured to provide access for the RTE module to native libraries.

28. The device of claim 27, wherein the native bridge is further configured to allow one or more native libraries to access script code.

29. The device of claim 25, further comprising:
a scripting shell module included in the scripting module, the scripting shell module configured to test the assembled application.

30. The device of claim 16, further comprising:
a web proxy server configured to facilitate access, for the computing device, to secure information received via the assembled application.

31. A method for dynamically assembling an application, comprising:
providing an application configuration to a first client device;
assembling, on the first client device, a first application based on the application configuration;
providing the application configuration to a second client device;
assembling, on the second client device, a second application based on the application configuration, the second application being different from the first application.

32. The method of claim 31, further comprising:
rendering a display of the first application on the first device;
rendering a display of the second application on the second device, the display of the first application being different from a display of the second application.

33. A system for dynamically assembling an application, the system comprising:
a first computing device comprising an application rendering engine, the engine comprising:
a network module configured to receive an application configuration; and
a run-time environment (RTE) module comprising:
a resource retrieval module configured to retrieve one or more application resources identified in the application configuration;
a storage for storing the one or more application resources; and
an assembling module configured to assemble the application based on the one or more application resources;
a second computing device comprising the application rendering engine,
wherein the assembling module of the first device is configured to assemble a first application and the assembling module of the second device is configured to assemble a second application different from the first application.

34. The system of claim 32, wherein the assembling module of the first device further comprises a layout module configured to prepare a display of the first application, and wherein the assembling module of the second device further comprise a layout module configured to prepare a display of the second application, the display of the first application being different from a display of the second application.
